(19) United States
(12) Patent Application Publication
(10) Pub. No.: US 2024/0392863 A1
(43) Pub. Date: Nov. 28, 2024

(54) ACTUATOR HAVING WIRING PATHWAY ARRANGEMENT

(71) Applicant: JTEKT Bearings North America LLC, Greenville, SC (US)

(72) Inventors: Trent L. Carpenter, Anderson, SC (US); Justin K. Brubaker, Greenville, SC (US); Matthew M. Maurer, Simpsonville, SC (US)

(21) Appl. No.: 18/672,687

(22) Filed: May 23, 2024

Related U.S. Application Data
(60) Provisional application No. 63/468,708, filed on May 24, 2023.

(51) Int. Cl. F16H 25/22; F16H 25/24

(52) U.S. Cl. CPC F16H 25/2204; F16H 25/24

(57) ABSTRACT

An actuator comprises a first portion and a second portion movable linearly with respect to each other between retracted and extended positions. At least one electronic component is carried by the first portion. A wiring support structure is carried by the second portion such that the first portion and the support structure will be closer together in the retracted position and farther apart in the extended position. A wiring pathway carries electrical wiring in electrical communication with the at least one electronic component, the wiring pathway extending from the first portion to the support structure.

### CROSS-REFERENCE TO RELATED APPLICATION

This application is based upon and claims priority to U.S. provisional patent application No. 63/468,708, filed May 24, 2023, which is incorporated herein in its entirety for all purposes.

### FIELD OF THE INVENTION

The present invention relates generally to actuators that move in a reciprocating fashion between retracted and extended positions.

### BACKGROUND OF THE INVENTION

Actuators having a reciprocating movement are used in a variety of applications. For example, lead screw or ball screw mechanisms in which a nut having inner threads (or a ball track) is located about a shaft having outer threads (or a ball track) are well known. Rotation of the shaft causes axial movement of the nut if the nut is fixed against rotation but is axially moveable. Likewise, if the shaft is fixed against rotation, it can be moved axially by rotation of the nut.

It is often desired to equip the nut with one or more sensors to detect various operating conditions. For example, US20220128136A1 shows a strain sensor attached to an outer surface of a ball screw nut for the detection of preload.

The present invention recognizes and addresses considerations of prior art constructions and methods.

### SUMMARY OF THE INVENTION

One aspect of the present invention provides an actuator comprising a first portion and a second portion movable linearly with respect to each other between retracted and extended positions. At least one electronic component (such as one or more sensors) is carried by the first portion. A wiring support structure is carried by the second portion such that the first portion and the wiring support structure will be closer together in the retracted position and farther apart in the extended position. A wiring pathway carries electrical wiring in electrical communication with the at least one electronic component, the wiring pathway extending from the first portion to the support structure. In some exemplary embodiments, the wiring pathway has a helical form and may be semi-rigid.

In some exemplary embodiments, the second portion rotates with respect to the first portion. For example, the first portion may be a ball screw nut and the second portion may be a ball screw shaft. The at least one electronic component may be mounted to a surface of the second portion.

In some exemplary embodiments, the wiring pathway may have a helical form and may preferably be semi-rigid. In some exemplary embodiments, the wiring pathway may comprise a polymeric spring carrying a plurality of conductors. The polymeric spring in such embodiments may define a channel in which the conductors are located. In some exemplary embodiments, the wiring pathway may comprise a semi-rigid ribbon cable formed in a helical shape. In such embodiments, at least one additional electrical component may be mounted on a surface of the ribbon cable. In some exemplary embodiments, the wiring pathway may have a formable spline extending alongside a plurality of conductors.

In some exemplary embodiments, the support structure may comprise a collar mounted on the second portion at a selected axial location, the second portion being rotatable with respect to the collar. In such embodiments, a connector may be mounted on the collar for connection of external wiring. In such embodiments, the electrical wiring of the wiring pathway may be attached to and extend through the collar.

In some exemplary embodiments, the at least one electronic component may comprise a sensor, such as at least one of a strain gauge, an accelerometer, a thermocouple, and a gyroscope.

Another aspect of the present invention provides an actuator comprising a first portion and a second portion movable linearly with respect to each other between retracted and extended positions. A wiring support structure is carried by the second portion such that the first portion and the support structure will be closer together in the retracted position and farther apart in the extended position. A wiring pathway carries electrical wiring in electrical communication with at least one electronic component mounted on the wiring pathway, the wiring pathway extending from the first portion to the support structure.

Another aspect of the present invention provides an actuator comprising a nut and a shaft rotatable with respect to one another such that one of the nut and the shaft moves axially with respect to the other. At least one electronic component is carried by the nut. A wiring support structure is carried by the shaft such that the nut and the support structure will be closer together in the retracted position and farther apart in the extended position, the support structure including a collar mounted on the shaft at a selected axial location. A wiring pathway carrying electrical wiring in electrical communication with the at least one electronic component is also provided. The wiring pathway according to this aspect has a helical shape and extends from the first portion to the support structure.

The accompanying drawings, which are incorporated in and constitute a part of this specification, illustrate one or more embodiments of the disclosure and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which;

FIGS. 1A and 1B illustrate an actuator in accordance with an embodiment of the present invention in retracted and extended positions, respectively;

FIG. 2 illustrates an exemplary wiring pathway arrangement that may be used in the actuator of FIGS. 1A and 1B;

FIG. 3 illustrates a pair of conductors having a semi-rigid spline that may be used in an exemplary wiring pathway arrangement according to the present invention;

FIG. 4 illustrates a semi-rigid ribbon cable that may be used in an exemplary wiring pathway arrangement according to the present invention;

FIG. 4A shows electronic and/or measurement components onboard a ribbon cable as in FIG. 4;

FIG. 5 illustrates a stationary support structure for pathway anchoring in accordance with an embodiment of the present invention; and

FIGS. 6A-6D illustrate alternative embodiments of a pathway arrangement in accordance with embodiments of the present invention.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

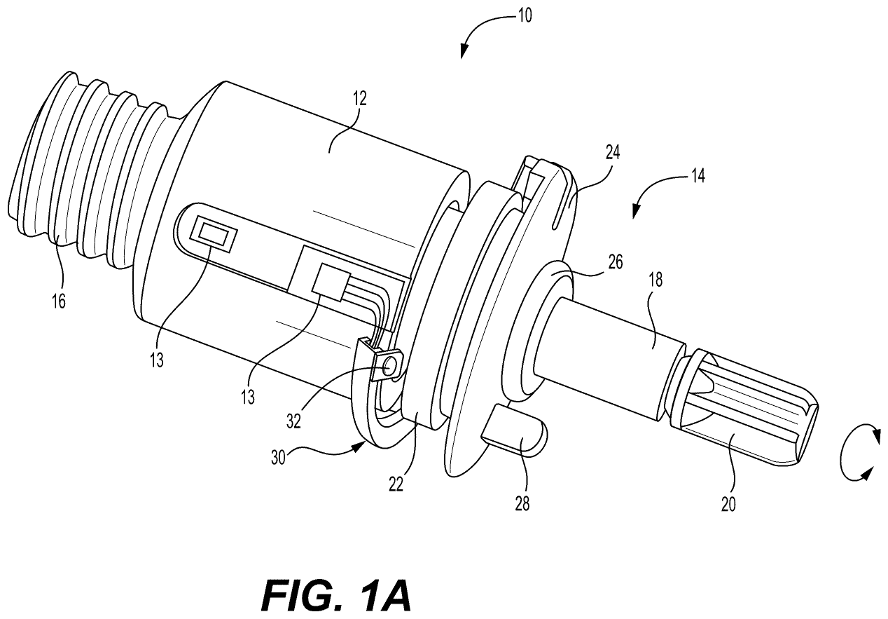

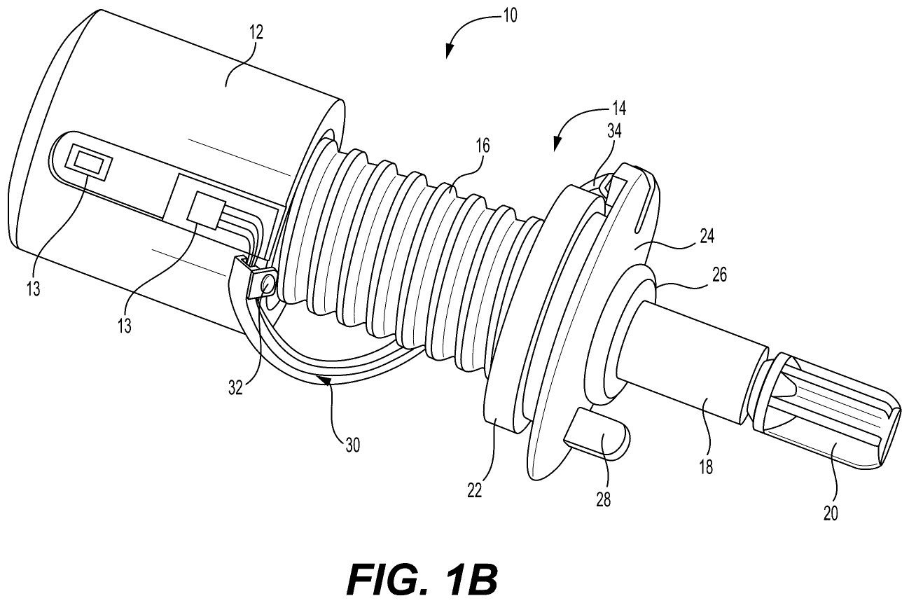

FIGS. 1A and 1B illustrate an actuator 10 constructed in accordance with an embodiment of the present invention. Actuator 10 includes a “nut” portion 12 that is fixed against rotation by a mating component that receives it. Nut 12 is equipped with one or more electronic components 13 typically including one or more sensors that collect data regarding the operating environment. Such electronic components may include, for example, one or more strain gauges, accelerometers, thermocouples, gyroscopes, wireless transmitters, etc., and/or signal processing electronics related to the foregoing.

Actuator 10 includes a rotatable portion (shaft) 14 having a cylindrical screw 16 received in the nut 12. In this embodiment, an axial extension 18 having a splined end 20 extends from screw 16, as shown. An integral flange 22 denotes the location at which screw 16 transitions to extension 18 and serves as a stop to limit the retraction of nut 12 relative to screw 16. A disk-like collar 24 is located on extension 18 adjacent to flange 22. Collar 24 may be held in place axially by any suitable retention mechanism such as a C-clip or the like. In the illustrated embodiment, however, a grommet 26 is located on extension 18 to retain collar 24.

The actuator 10 in this case moves between retracted and extended positions by rotation of rotatable portion 14. In particular, splined portion 20 is received into the output of a driver (such as a small electric motor) that causes extension 18, and thus screw 16, to turn. As a result, there will be relative linear movement between nut 12 and rotatable portion 14. In other embodiments, the nut may be axially fixed but rotatably driven with the shaft being fixed against rotation. In such embodiments, the shaft itself will move axially as the nut is turned.

Actuator 10 may, for example, be configured as a lead screw in which inner threads of the nut engage outer threads of the shaft. Alternatively, actuator 10 may be configured as ball screw in which the nut and shaft define inner and outer helical ball tracks, respectively. In this case, a plurality of rolling elements are located in the opposed ball tracks. The rolling elements may recirculate or not depending on the embodiment. Moreover, while actuator 10 is shown having a rotatable arrangement to provide the linear movement, one skilled in the art will appreciate that suitable nonrotatable linear actuators may also be used.

Collar 24, however, is mounted to extension 18 so as to allow relative rotation therebetween. Preferably, collar 24 is fixed with respect to adjacent structure against rotation, thus allowing extension 18 to rotate within it. In this example, collar 24 includes an axial tab 28 received in a keyway defined in adjacent structure to prevent rotation of collar 24.

Actuator 10 further includes a wiring pathway arrangement (“pathway”) 30 extending between nut 12 and collar 24. Pathway 30 may provide power and signal wiring, as necessary or desired, to the electronic component(s) 13 of nut 12 while allowing the linear movement of actuator 10 between retracted and extended positions as described above. In this embodiment, pathway 30 has a semi-rigid structure that extends helically at least partially around the axis of screw 16 between location 32 on nut 12 and location 34 on collar 24. (As used herein, the term “semi-rigid” denotes a structure that normally retains and/or returns to an at-rest state but is flexible enough to allow movement between nut 12 and collar 24 as described.) As actuator 10 is moved between retracted and extended positions, the axial length of pathway 30 changes accordingly in a manner similar to compression and extension of a coil spring. Pathway 30 may have a connector at location 34 where the external application is electrically connected to the electronic components of nut 12. Alternatively, a suitable grommet may be positioned at location 34 so as to fix pathway 30 to collar 34 but allowing the wiring to continue to another location for connection to the application.

One skilled in the art will appreciate that any suitable means of attaching pathway 30 to nut 12 and/or collar 24 may be utilized, including, for example, threaded fasteners, adhesives, mechanical fasteners such as clips, tabs, hooks and the like which provide sufficient interference between components to provide retention.

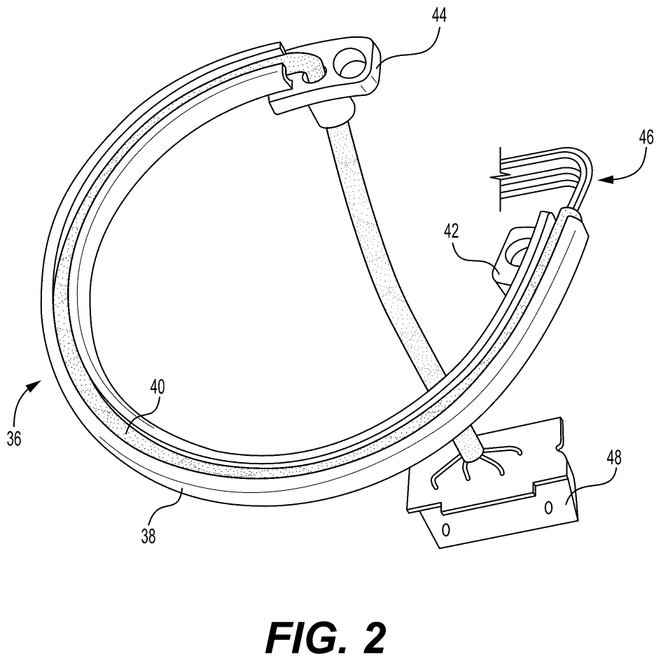

FIG. 2 illustrates one embodiment of pathway 30 in the form of a polymeric spring 36. As shown, spring 36 has a spring member 38 in the form of a partial circle defining a channel in which the wiring 40 is received. As shown, spring 36 has integral tabs 42 and 44 in this embodiment for effecting attachment to the nut 12 and collar 24, respectively. Wiring 40 has an outer sheath in which individual conductors 46 are contained. A connector 48 allows connection of the conductors to the application.

Embodiments are contemplated in which spring 36 is formed by overmolding on a section of wiring 40 such that spring 36 and wiring 40 become an inseparable unit. A bendable metal wire may be located alongside wiring 40 prior to such overmolding such it will be part of the final overmolded assembly. The bendable wire in such embodiments may be used only to provide rigidity and “memory” to pathway 30, not for electrical conduction.

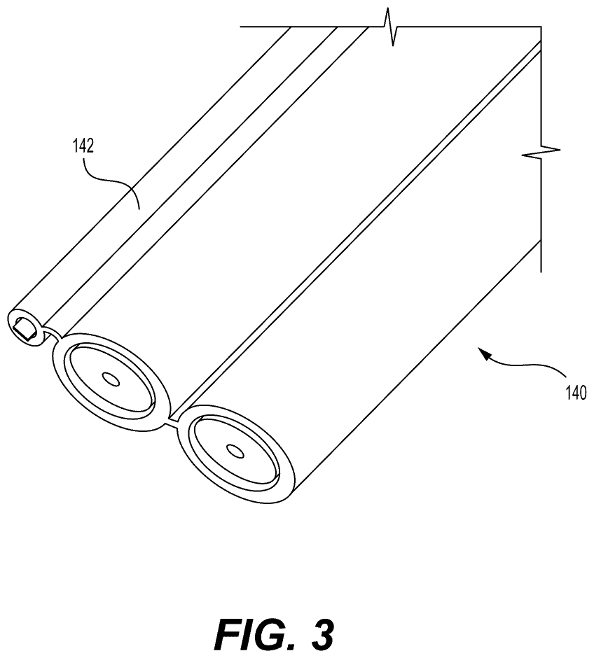

Alternatively, as shown in FIG. 3, wiring 140 having a formable spline 142 may be formed into the desired helix shape and used as pathway 30. Similarly, pathway 30 may be formed of a hollow tube of metal or plastic made into a helical configuration with wiring 40 located inside of the tube.

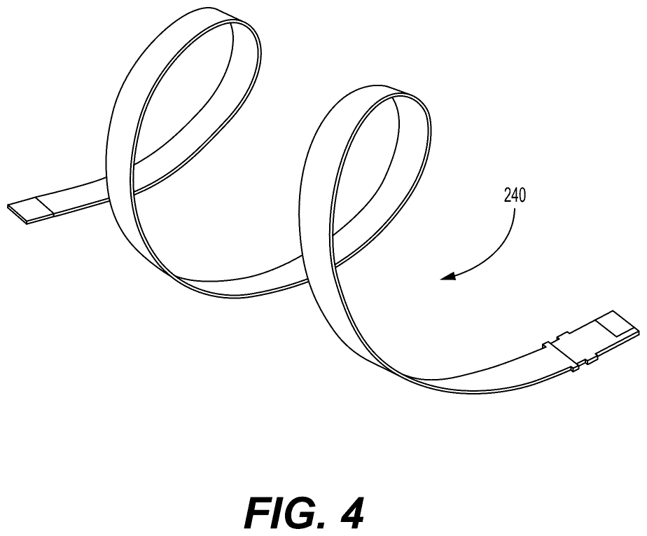

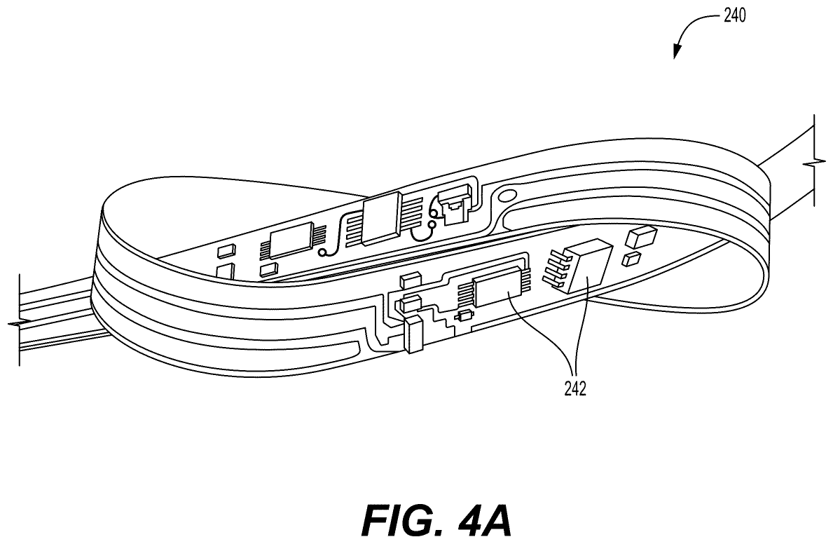

FIG. 4 illustrates an alternative embodiment in which a semirigid ribbon cable 240 is formed into a helical shape for use as pathway 30. As shown in FIG. 4A, various electronic components 242 may be located on the surface of ribbon cable 240 as necessary or desired.

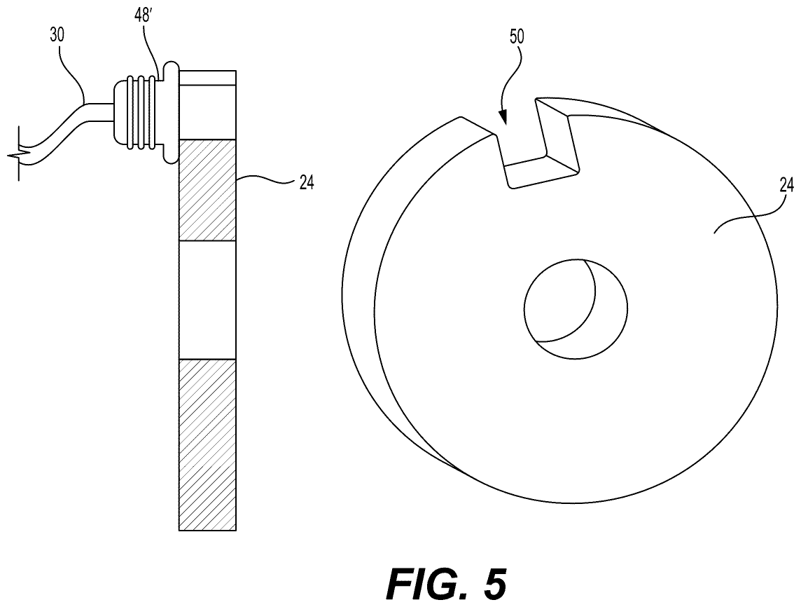

Referring now to FIG. 5, it will be appreciated that collar 24 serves as a stationary support structure for anchoring of pathway 30. In this case, a connector 48′ is suitably attached (e.g., by being clipped or otherwise locked) into a notch 50 defined in the periphery of collar 24.

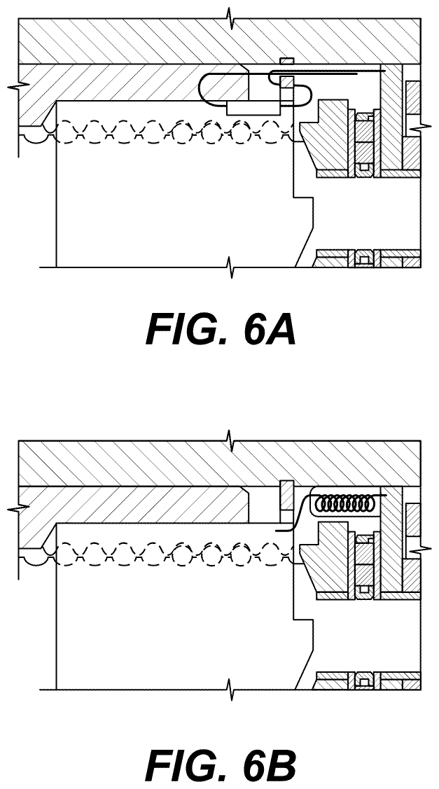

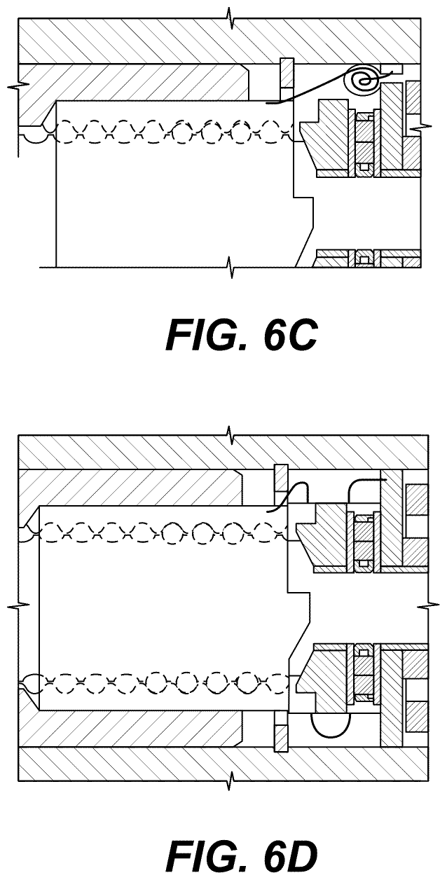

Other embodiments for providing electrical conductivity between the nut 12 and the external application are shown in FIGS. 6A-D. In this regard, FIG. 6A shows a “cable tray” in which conductors are attached to/within a folding semi-rigid pathway device which folds/unfolds as the actuator extends/retracts. FIG. 6B shows a “tunnel/telephone cord” embodiment in which conductors are formed into a spiral/coil via overmolding or conductors pass through spiral/coil which extends/retracts with the actuator. FIG. 6C illustrates a “winch/spool” in which conductors are allowed to extend/retract to and from a spool/bobbin structure which may or may not be spring assisted. FIG. 6D illustrates a “clock spring” embodiment in which conductors are formed into a coil or other labyrinth accommodating enough conductor length to extend/retract the full extent of the actuator. (The various alternatives of FIGS. 6A-6D are shown in a ball-screw embodiment in which the balls between the ball tracks can be seen.)

While one or more preferred embodiments of the invention are described above, it should be appreciated by those skilled in the art that various modifications and variations can be made in the present invention without departing from the scope and spirit thereof.

What is claimed is:

1. An actuator comprising:
a first portion and a second portion movable linearly with respect to each other between retracted and extended positions;
at least one electronic component carried by the first portion;
a wiring support structure carried by the second portion such that the first portion and the support structure will be closer together in the retracted position and farther apart in the extended position; and
a wiring pathway carrying electrical wiring in electrical communication with the at least one electronic component, the wiring pathway extending from the first portion to the support structure.

2. The actuator of claim 1, wherein the second portion rotates with respect to the first portion.

3. The actuator of claim 2, wherein the first portion is a ball screw nut and the second portion is a ball screw shaft.

4. The actuator of claim 2, wherein the at least one electronic component is mounted to a surface of the second portion.

5. The actuator of claim 1, wherein the wiring pathway has a helical form.

6. The actuator of claim 5, wherein the wiring pathway is semi-rigid.

7. The actuator of claim 5, wherein the wiring pathway comprises a polymeric spring carrying a plurality of conductors.

8. The actuator of claim 7, wherein the polymeric spring defines a channel in which the conductors are located.

9. The actuator of claim 5, wherein the wiring pathway comprises a semi-rigid ribbon cable formed in a helical shape.

10. The actuator of claim 5, wherein at least one additional electrical component is mounted on a surface of the ribbon cable.

11. The actuator of claim 5, wherein the wiring pathway has a formable spline extending alongside a plurality of conductors.

12. The actuator of claim 2, wherein the support structure comprises a collar mounted on the second portion at a selected axial location, the second portion being rotatable with respect to the collar.

13. The actuator of claim 12, wherein a connector is mounted on the collar for connection of external wiring.

14. The actuator of claim 12, wherein the electrical wiring of the wiring pathway is attached to and extends through the collar.

15. The actuator of claim 1, wherein the at least one electronic component comprises a sensor.

16. The actuator of claim 15, wherein the sensor comprises at least one of a strain gauge, an accelerometer, a thermocouple, and a gyroscope.

17. An actuator comprising:
a first portion and a second portion movable linearly with respect to each other between retracted and extended positions;
a wiring support structure carried by the second portion such that the first portion and the support structure will be closer together in the retracted position and farther apart in the extended position; and
a wiring pathway carrying electrical wiring in electrical communication with at least one electronic component mounted on the wiring pathway, the wiring pathway extending from the first portion to the support structure.

18. An actuator as set forth in claim 17, wherein wiring pathway comprises a semi-rigid ribbon cable formed in a helical shape.

19. The actuator of claim 18, wherein the support structure comprises a collar mounted on the second portion at a selected axial location, the second portion being rotatable with respect to the collar.

20. An actuator comprising:
a nut and a shaft rotatable with respect to one another such that one of the nut and the shaft moves axially with respect to the other;
at least one electronic component carried by the nut;
a wiring support structure carried by the shaft such that the nut and the support structure will be closer together in the retracted position and farther apart in the extended position, the support structure including a collar mounted on the shaft at a selected axial location; and
a wiring pathway carrying electrical wiring in electrical communication with the at least one electronic component, the wiring pathway having a helical shape and extending from the first portion to the support structure.
